(19) United States
(12) Patent Application Publication
(10) Pub. No.: US 2016/0034793 A1
(43) Pub. Date: Feb. 4, 2016

(54) IMAGE FORMING APPARATUS, METHOD FOR GENERATING PIXEL INFORMATION, AND NON-TRANSITORY RECORDING MEDIUM

(71) Applicant: Tomoaki OKAMURA, Tokyo (JP)

(72) Inventor: Tomoaki OKAMURA, Tokyo (JP)

(73) Assignee: Ricoh Company, Ltd., Tokyo (JP)

(21) Appl. No.: 14/802,224

(22) Filed: Jul. 17, 2015

(30) Foreign Application Priority Data
Aug. 1, 2014 (JP) 2014-157858

(51) Int. Cl. G06K 15/02; G06F 3/12

(52) U.S. Cl. CPC G06K 15/1851; G06K 15/1807; G06K 15/1811; G06K 15/1852; G06F 3/1241; G06F 3/1248; H04N 2201/0094

(57) ABSTRACT

In generating pixel information to be used for printing an image, an apparatus generates command data for executing configuration to a figure in the image so as to include area information indicating a configuration target area of the image. When generating pixel information, the apparatus reads actual data indicating the content of the configuration, only when a range indicated by the area information of the command data is included at least partially in a target divided area of the printing target image.

### CROSS-REFERENCE TO RELATED APPLICATIONS

This patent application is based on and claims priority pursuant to 35 U.S.C. §119(a) to Japanese Patent Application No. 2014-157858, filed on Aug. 1, 2014, in the Japan Patent Office, the entire disclosure of which is hereby incorporated by reference herein.

### BACKGROUND

1. Technical Field

The present invention relates to an image forming apparatus, a method of generating pixel information, and a non-transitory recording medium storing a program for generating pixel information.

2. Description of the Related Art

In recent years, more and more information has been computerized as computerized information, and an image processing apparatus such as a printer or a facsimile used for outputting the computerized information and a scanner used for computerizing documents has become an essential apparatus. Such an image processing apparatus is often configured as a multifunction peripheral that can be used as a printer, a facsimile, a scanner, and a copier by having an imaging function, a print function, a communication function, and the like.

Among such image processing apparatuses, in an image forming apparatus such as a printer used for outputting the computerized information, a print engine performs image processing (hereinafter referred to as a drawing process) of generating drawing information for executing printing based on input image information. This image processing is accelerated by dedicated hardware as well as when executed by an arithmetic unit such as a central processing unit (CPU) operating according to software.

### SUMMARY

Example embodiments of the present invention include an apparatus, method, and a program stored in a non-transitory recording medium, each of which is capable of generating pixel information to be used for printing an image. For example, the apparatus generates figure information in which items of information are grouped for each figure to be drawn in a printing target image based on a print execution command. The figure information includes: drawing information of the figure including command data for executing drawing and actual data indicating the content of the drawing; and configuration information of the figure including command data for executing configuration and actual data indicating the content of the configuration, the command data of the configuration information including area information indicating a configuration target area of the printing target image to which the configuration is applied. The apparatus reads the actual data only when a range indicated by the area information of the command data is included at least partially in a target divided area of the printing target image, and generates pixel information of each pixel forming the printing target image based on the figure information using the read actual data, for each one of a plurality of divided areas of the printing target image.

### BRIEF DESCRIPTION OF THE SEVERAL VIEWS OF THE DRAWINGS

A more complete appreciation of the disclosure and many of the attendant advantages and features thereof can be readily obtained and understood from the following detailed description with reference to the accompanying drawings, wherein:

FIG. 1 is a block diagram of a hardware configuration of an image forming apparatus according to an embodiment of the present invention;

FIG. 2 is a diagram of a functional configuration of the image forming apparatus according to an embodiment of the present invention;

FIG. 3 is a block diagram of the functions included in an image processor according to an embodiment of the present invention;

FIG. 4 is a diagram of a configuration of intermediate data according to an embodiment of the present invention;

FIG. 5 is a diagram of how intermediate data is read according to an embodiment of the present invention;

FIG. 6 is a diagram of the content of an image drawing command according to an embodiment of the present invention;

FIG. 7 is a diagram of the content of a general dither configuration command;

FIG. 8 is a diagram of an example of an object layout according to an embodiment of the present invention;

FIG. 9 is a diagram of the order in which command data is read according to an embodiment of the present invention;

FIG. 10 is a diagram of how command data is skipped according to an embodiment of the present invention;

FIG. 11 is a diagram of how command data is skipped according to an embodiment of the present invention;

FIG. 12 is a flowchart of an intermediate data generation operation according to an embodiment of the present invention;

FIG. 13 is a diagram of an example of print data according to an embodiment of the present invention;

FIG. 14 is a diagram of the content of a dither configuration command according to an embodiment of the present invention;

FIG. 15 is a flowchart of a band data generation operation according to an embodiment of the present invention;

FIG. 16 is a diagram of the content of a dither configuration command according to an embodiment of the present invention; and

FIG. 17 is a diagram of the content of a dither configuration command according to an embodiment of the present invention.

The accompanying drawings are intended to depict example embodiments of the present invention and should not be interpreted to limit the scope thereof. The accompanying drawings are not to be considered as drawn to scale unless explicitly noted.

### DETAILED DESCRIPTION

The terminology used herein is for the purpose of describing particular embodiments only and is not intended to be limiting of the present invention. As used herein, the singular forms “a”, “an” and “the” are intended to include the plural forms as well, unless the context clearly indicates otherwise. It will be further understood that the terms “includes” and/or “including”, when used in this specification, specify the presence of stated features, integers, steps, operations, elements, and/or components, but do not preclude the presence or addition of one or more other features, integers, steps, operations, elements, components, and/or groups thereof.

In describing example embodiments shown in the drawings, specific terminology is employed for the sake of clarity. However, the present disclosure is not intended to be limited to the specific terminology so selected and it is to be understood that each specific element includes all technical equivalents that operate in a similar manner.

In the following description, illustrative embodiments will be described with reference to acts and symbolic representations of operations (e.g., in the form of flowcharts) that may be implemented as program modules or functional processes including routines, programs, objects, components, data structures, etc., that perform particular tasks or implement particular abstract data types and may be implemented using existing hardware at existing network elements or control nodes. Such existing hardware may include one or more Central Processing Units (CPUs), digital signal processors (DSPs), application-specific-integrated-circuits, field programmable gate arrays (FPGAs) computers or the like. These terms in general may be referred to as processors.

Unless specifically stated otherwise, or as is apparent from the discussion, terms such as “processing” or “computing” or “calculating” or “determining” or “displaying” or the like, refer to the action and processes of a computer system, or similar electronic computing device, that manipulates and transforms data represented as physical, electronic quantities within the computer system's registers and memories into other data similarly represented as physical quantities within the computer system memories or registers or other such information storage, transmission or display devices.

When images are processed using dedicated hardware, a read speed can be accelerated by storing the data to be read by the hardware in a dedicated memory. Here, the data to be read by the hardware includes command data and actual data.

The command data is the data of a command (hereinafter referred to as a “drawing command”) for drawing an object such as a picture or a letter included in an image and the data of a command (hereinafter referred to as a “configuration command”) for designating dithering or y-correction. In contrast, the actual data is the data (hereinafter referred to as “drawing data”) of an object such as a picture or a letter and the actual data (hereinafter referred to as “configuration data”) of a dithering value or a y-correction value.

The dedicated memory has a limited volume whereas the actual data has a large size. Thus, only the command data among the command data and the actual data is stored in the dedicated memory, and the actual data is generally stored in a shared memory. Therefore, the actual data is read from the shared memory in response to reading of the command data.

In general, when an image forming apparatus processes images, areas called “bands” obtained by dividing the image of each page into a plurality of areas in a sub-scanning direction are processed. Thus, the hardware that performs image processing reads a command for an object included in a target band in which drawing information is generated, from a dedicated memory and reads actual data from a shared memory according to the information described in the command.

The data that describes the content of the image in each page is a collection of the command data and actual data. The command data and the actual data are not created for respective bands but may be created for a plurality of bands depending on an object. Thus, image processing is executed based on the information of an object included in a target band.

In this case, if it is possible to determine in which band each object is included based on the content of the command data, reading of the actual data can be omitted. In general, since the position of each object on a page is described in a drawing command, it is possible to omit such a process (that is, the reading of the actual data can be omitted since such an object is not included in a target band).

In contrast, since configuration data is generally configured for each page rather than for each object, the configuration command does not include the information on the position on a page. As a result, even if a band does not include image data, for example, actual data such as a dithering value or a y-correction value for the image data is read unnecessarily, which makes processing inefficient.

From the above, if the reading of information that is not associated with a target area is omitted, image processing of generating drawing information can be performed more efficiently.

Hereinafter, an embodiment of the present invention will be described in detail with reference to the drawings. In the present embodiment, an image forming apparatus as a multifunction peripheral (MFP) including the functions of a printer, a scanner, a copier, and the like will be described by way of an example. The image forming apparatus according to the present embodiment processes a print job when the print job is received to execute printing.

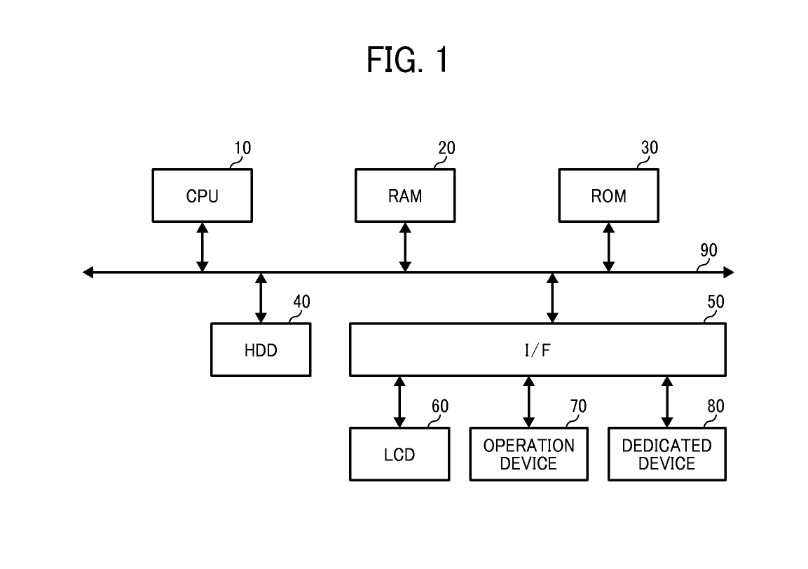

FIG. 1 is a block diagram of a hardware configuration of a control system of an image forming apparatus 1 according to the present embodiment. As illustrated in FIG. 1, the control system of the image forming apparatus 1 according to the present embodiment has the same configuration as an information processing apparatus such as a general personal computer (PC) or a server. That is, the control system of the image forming apparatus 1 according to the present embodiment includes a central processing unit (CPU) 10, a random access memory (RAM) 20, a read only memory (ROM) 30, a hard disk drive (HDD) 40, and an I/F 50 which are connected by a bus 90. Moreover, a liquid crystal display (LCD) 60, an operation device 70, and a dedicated device 80 are connected to the I/F 50.

The CPU 10, implemented by one or more processors, controls the operation of the entire image forming apparatus 1. The RAM 20 is a volatile memory that the CPU 10 is capable of reading and writing information at high speed therefrom or thereto, and is used as a work area when the CPU 10 processes information. The ROM 30 is a read-only nonvolatile memory and stores a program such as firmware therein. The HDD 40 is a nonvolatile memory that the CPU 10 is capable of reading and writing information therefrom or thereto and stores an operating system (OS), various control programs, application programs, and the like.

The I/F 50 connects various hardware components and networks, and the like to the bus 90 and controls the same. The LCD 60 is a visual user interface that allows a user to check the state of the image forming apparatus 1. The operation device 70 is a user interface that allows a user to input information to the image forming apparatus 1 and includes a touch panel, hard keys, and the like.

The dedicated device 80 is a hardware component for realizing the dedicated functions of the image forming apparatus 1 and includes a conveying mechanism that conveys a printing target sheet and a plotter that executes printing on a sheet surface. The dedicated device 80 further includes a dedicated computing device for performing image processing at high speed. Such computing device is configured as an application specific integrated circuit (ASIC), for example.

In such a hardware configuration, the CPU 10 performs operation according to the program stored in the ROM 30 or the program read into the RAM 20 from the HDD 40 or a recording medium such as an optical disc, to implement a software controller. The software controller and the hardware components operate in cooperation to achieve the functions of the image forming apparatus 1 according to the present embodiment.

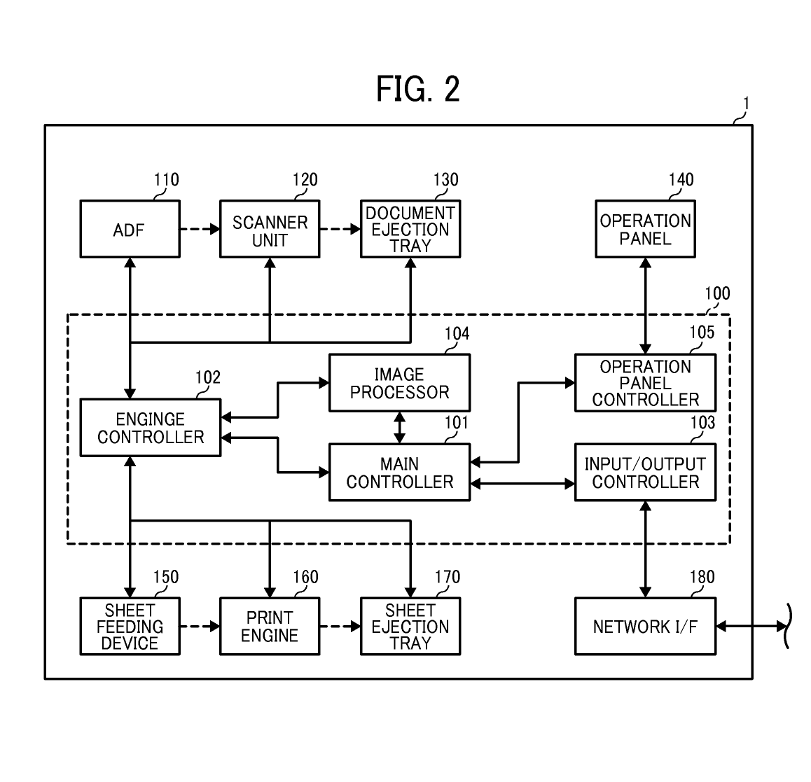

Next, a configuration of the image forming apparatus 1 according to the present embodiment will be described with reference to FIG. 2, when the image forming apparatus 1 is implemented as a multifunctional peripheral. FIG. 2 is a block diagram of the configuration of the image forming apparatus 1 according to the present embodiment. As illustrated in FIG. 2, the image forming apparatus 1 according to the present embodiment includes a controller 100, an auto document feeder (ADF) 110, a scanner unit 120, a document ejection tray 130, an operation panel 140, a sheet feeding device 150, a print engine 160, a sheet ejection tray 170, and a network I/F 180.

Moreover, the controller 100 includes a main controller 101, an engine controller 102, an input/output controller 103, an image processor 104, and an operation panel controller 105. As illustrated in FIG. 2, the image forming apparatus 1 according to the present embodiment is configured as a multifunction peripheral that includes a scanner unit 120 and a print engine 160. In FIG. 2, electrical connections are depicted by solid-line arrows and the flow of a sheet is depicted by broken-line arrows.

The operation panel 140 operates as an output interface for visually displaying the state of the image forming apparatus 1, and as an input interface (operation device) with a touch panel for allowing the user to operate the image forming apparatus 1 directly or to input information to the image forming apparatus 1. The network I/F 180 is an interface for allowing the image forming apparatus 1 to communicate with other apparatuses via a network, which may be implemented by an Ethernet (registered trademark) interface or a universal serial bus (USB) interface.

The controller 100 is configured as a combination of software and hardware components as described above. The controller 100 functions as a controller that controls the entire image forming apparatus 1.

The main controller 101 controls the respective units included in the controller 100 and issues commands to the respective units of the controller 100. The engine controller 102 controls or drives the print engine 160, the scanner unit 120, or the like. The input/output controller 103 inputs signals and commands input via the network I/F 180 to the main controller 101. Moreover, the main controller 101 controls the input/output controller 103 and accesses other apparatuses via the network I/F 180.

The image processor 104 generates drawing data based on print information included in an input print job under control of the main controller 101. The drawing data is information for allowing the print engine 160 which is an image forming unit to draw an image to be formed in printing, such as pixel information (that is, bitmap data) in which a printing target image is expressed as the information of each pixel.

Moreover, the print information included in a print job is information which is converted into such a format as to be recognized by the image forming apparatus 1 by a printer driver installed in an information processing apparatus such as a PC and is information described in page description language (PDL). In other words, the print information is page information in which the information on a page to be printed is described.

In the present embodiment, the image processor 104 generates intermediate data based on a print job as a preliminary step of drawing data when generating the drawing data based on the print job. The function of the image processor 104 will be described in detail later. The operation panel controller 105 displays information on the operation panel 140 or inform the main controller 101 of the information input via the operation panel 140.

When the image forming apparatus 1 operates as a printer, first, the input/output controller 103 receives a print job via the network I/F 180 from the outside apparatus. The input/output controller 103 transmits the received print job to the main controller 101. Upon receiving the print job, the main controller 101 controls the image processor 104 to generate drawing data based on print information included in the print job.

When the drawing data is generated by the image processor 104, the engine controller 102 executes printing on a sheet conveyed from the sheet feeding device 150 based on the generated drawing data. That is, the print engine 160 functions as an image forming unit. As a specific aspect of the print engine 160, an inkjet printing mechanism, an electrophotographic printing mechanism, and other mechanisms can be used, for example. A document on which an image has been printed by the print engine 160 is ejected to the sheet ejection tray 170.

In another example, when the image forming apparatus 1 operates as a copier, the image processor 104 generates drawing data based on scanned data that the engine controller 102 has received from the scanner unit 120 or image information that the image processor 104 has generated based on the scanned data. The engine controller 102 drives the print engine 160 based on the drawing data similarly to the printing operation.

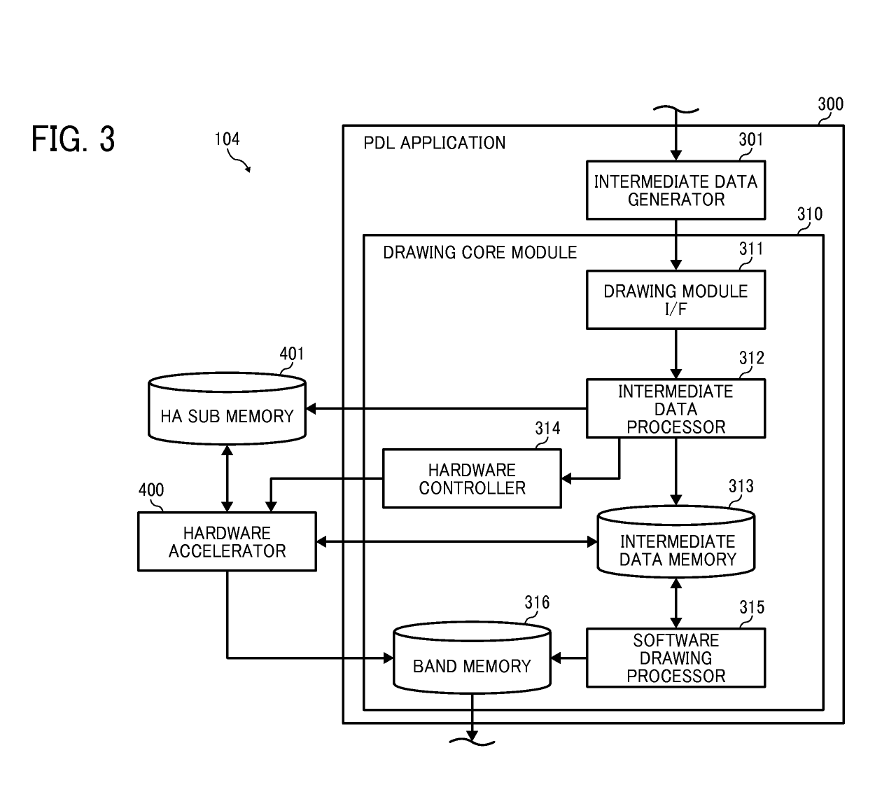

Hereinafter, the functions and operations of the image processor 104 according to the present embodiment will be described. FIG. 3 is a block diagram of a configuration of the image processor 104 according to the present embodiment. As illustrated in FIG. 3, the image processor 104 according to the present embodiment includes a PDL application 300, a hardware accelerator 400, and a hardware accelerator (HA) sub memory 401.

The PDL application 300 is a software module which is implemented by the CPU 10 according to a software program. As illustrated in FIG. 3, the PDL application 300 includes an intermediate data generator 301 and a drawing core module 310. The intermediate data generator 301 acquires print information described in PDL and converts the same into intermediate data which is such a type of data that can be processed by the drawing core module 310 or the hardware accelerator 400.

Examples of the format of PDL according to the present embodiment include Postscript, printer command language (PCL), and refined printing command stream (RPCS). The intermediate data generator 301 converts print information which can be input in these various formats into intermediate data of a predetermined format. The process of generating the intermediate data is referred to as a parsing process and the intermediate data generator 301 is referred to as a parser.

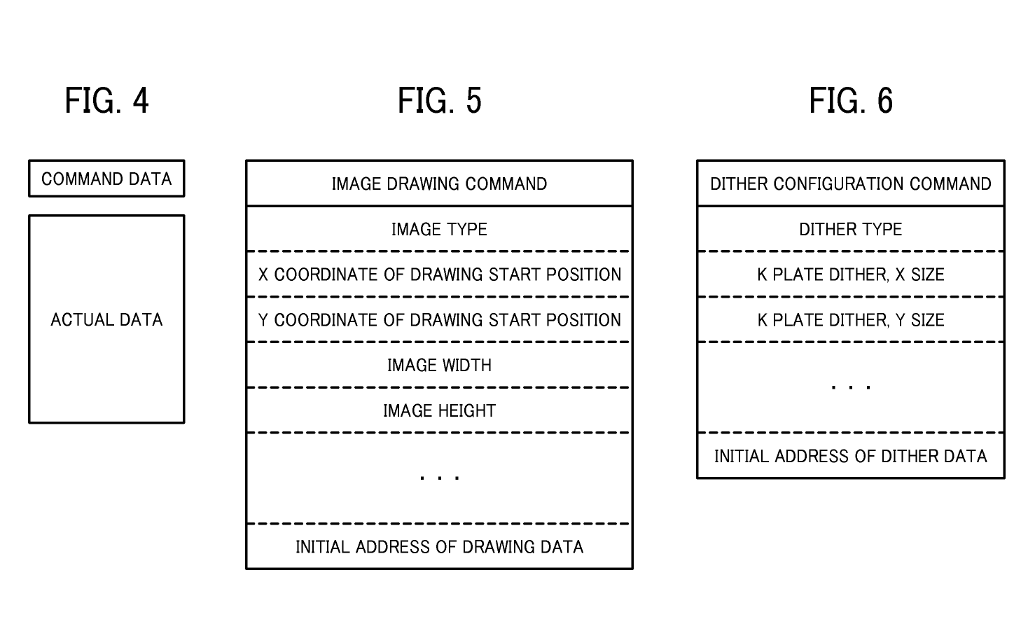

FIG. 4 is a diagram of an example of information included in the intermediate data according to the present embodiment. The intermediate data according to the present embodiment is information in which items of information are grouped for each object included in a printing target image. When a plurality of objects is included in a printing target image, intermediate data is generated for respective objects. In other words, the intermediate data is figure information in which items of information are grouped for each figure to be drawn in an image. Thus, the intermediate data generator 301 functions as a figure information generator.

As illustrated in FIG. 4, the intermediate data according to the present embodiment includes command data and actual data. The command data is information for a drawing command for an object such as a picture, a letter, or a figure, and an image configuration command such as dithering or y-correction. The actual data is the actual image data of the object and actual configuration value associated with the image configuration command (that is, the actual data is actual information).

That is, the drawing command and the actual image data are used as information on drawing of figures, and the configuration command and the actual configuration data are used as information on configuration.

FIG. 5 is a diagram of the content of an image drawing command. As illustrated in FIG. 5, the image drawing command includes an “image type,” an “X coordinate of drawing start position,” a “Y coordinate of drawing start position,” an “image width,” an “image height,” and an “initial address of drawing data”. In FIG. 5, the “X coordinate of drawing start position,” the “Y coordinate of drawing start position,” the “image width,” and the “image height” are used as the information of the position of the object displayed on an image.

FIG. 6 is a diagram of the content of a general dither configuration command. As illustrated in FIG. 6, the dither configuration command includes a “dither type,” a “K plate dither, X size,” a “K plate dither, Y size,” and an “initial address of dither data”.

As illustrated in FIGS. 5 and 6, in the case of the image drawing command, it is possible to determine an area on a page in which a corresponding object is included based on the information “X coordinate of drawing start position,” “Y coordinate of drawing start position,” “image width,” and “image height”. In contrast, since the dither command or the y-correction command which is configured for an entire page does not need to describe the position on a page, such a determination is not needed.

The drawing core module 310 acquires the intermediate data generated by the intermediate data generator 301 and generates drawing data for allowing the print engine 160 to execute printing. As illustrated in FIG. 3, the drawing core module 310 includes a drawing module I/F 311, an intermediate data processor 312, an intermediate data memory 313, a hardware controller 314, a software drawing processor 315, and a band memory 316.

The drawing module I/F 311 is an interface for allowing the drawing core module 310 to acquire information from external apparatuses and acquires the intermediate data generated by the intermediate data generator 301. The intermediate data processor 312 stores the intermediate data acquired by the drawing module I/F 311 in the intermediate data memory 313 and the HA sub memory 401.

The intermediate data processor 312 according to the present embodiment stores the intermediate data acquired via the drawing module I/F 311 in the intermediate data memory 313 and copies and stores the command data among the items of data included in the intermediate data in the HA sub memory 401. The intermediate data memory 313 is a storage area secured in the RAM 20.

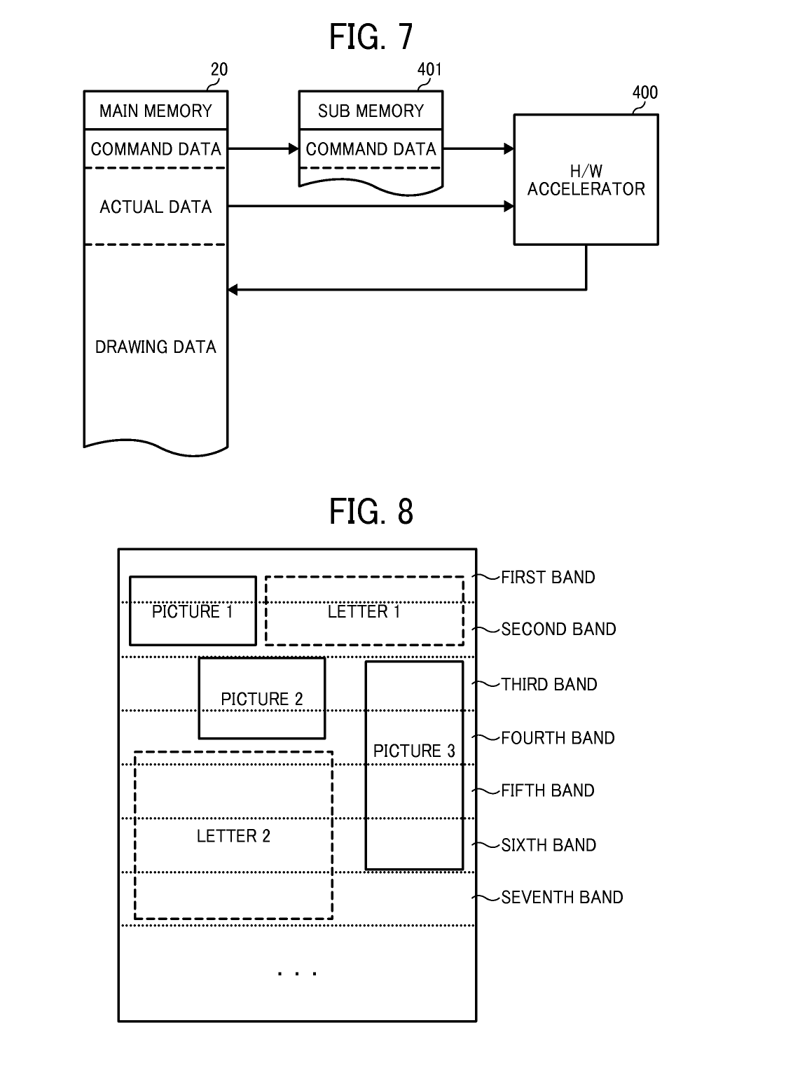

The hardware controller 314 allows the hardware accelerator 400 to execute image processing in accordance with the process of the intermediate data processor 312 storing the intermediate data. FIG. 7 is a diagram for explaining how drawing data is generated based on the intermediate data according to the present embodiment.

As illustrated in FIG. 7, the hardware accelerator 400 is an integrated circuit that generates drawing data based on intermediate data. The hardware accelerator 400 reads such command data as illustrated in FIGS. 5 and 6 from the HA sub memory 401 and reads actual data from the intermediate data memory 313 based on the address designated in the command data such as the “initial address of drawing data” or the “initial address of dither data”. Drawing data is generated based on the command data and the actual data acquired in this manner.

The software drawing processor 315 is a drawing processor that is configured as a software module. The band memory 316 is a storage area for storing the drawing data generated by the software drawing processor 315 or the hardware accelerator 400. The band memory 316 is a storage area secured in the RAM 20.

The software drawing processor 315 and the hardware accelerator 400 according to the present embodiment generate drawing data for respective image areas called “bands”. The “bands” are respective divided areas obtained by dividing a printing target image into a plurality of areas in a sub-scanning direction. Thus, the generated drawing data is also stored in the band memory 316 for respective bands.

The hardware accelerator 400 is a hardware module that executes image processing with the aid of hardware components and is realized by the dedicated device 80 described in FIG. 1. The HA sub memory 401 is a dedicated storage medium provided for a dedicated purpose for allowing the hardware accelerator 400 to read information at high speed and is realized by the dedicated device 80 described in FIG. 1. In contrast, the RAM 20 is used as a shared storage medium that is shared for a plurality of purposes.

Next, a band-based drawing process according to the present embodiment will be described. FIG. 8 is a diagram of an example of a target page in which drawing data is generated and how the page is divided into bands. In the example of FIG. 8, the target page includes “picture 1,” “picture 2,” and “picture 3” as image data and “letter 1” and “letter 2” as letter data. In FIG. 8, the vertical axis is the Y-direction and the horizontal axis is the X-direction.

“Picture 1” extends over the first and second bands, and “picture 2” extends over the third and fourth bands. Moreover, “picture 3” extends over the third to sixth bands. “Letter 1” extends over the first and second bands and “letter 2” extends over the fourth to seventh bands.

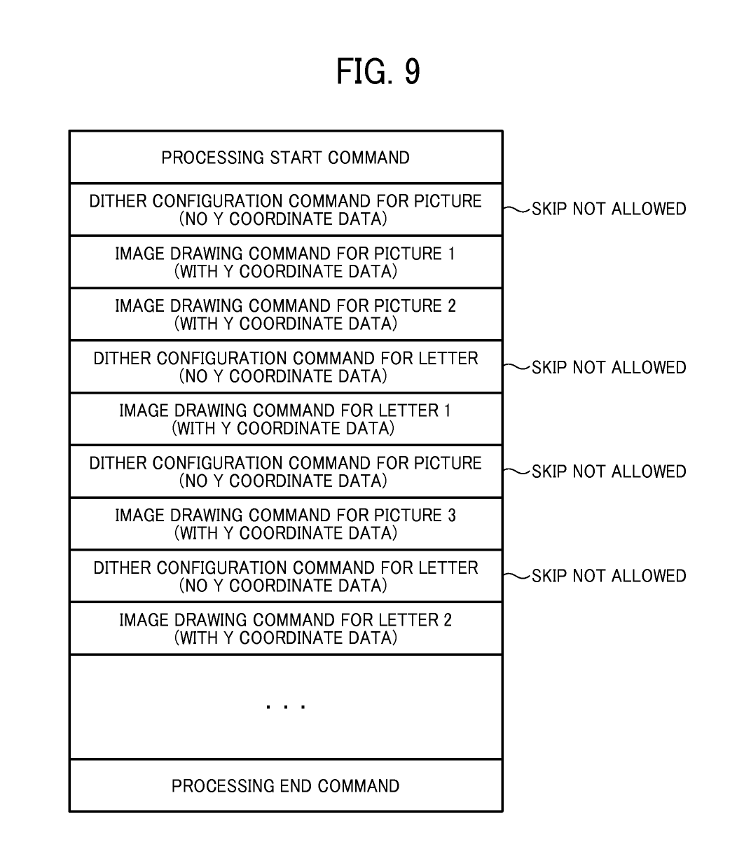

FIG. 9 is a diagram of an example of the command data stored in the HA sub memory 401. As illustrated in FIG. 9, the command data is stored so that the dither configuration command is read ahead of the drawing command for pictures or letters. As illustrated in FIG. 9, different dither configuration commands are generated for drawing of pictures and letters. In the following description, although the dither configuration command is described by way of an example, the same can be applied to other commands configured in image processing such as a configuration command for a y-correction value.

As illustrated in FIG. 9, when the command data is read sequentially starting with a processing start command, dither configuration commands corresponding to the type of drawing such as a picture or a letter are read ahead of a drawing command, and corresponding dithering is configured for a drawing process for pictures or letters.

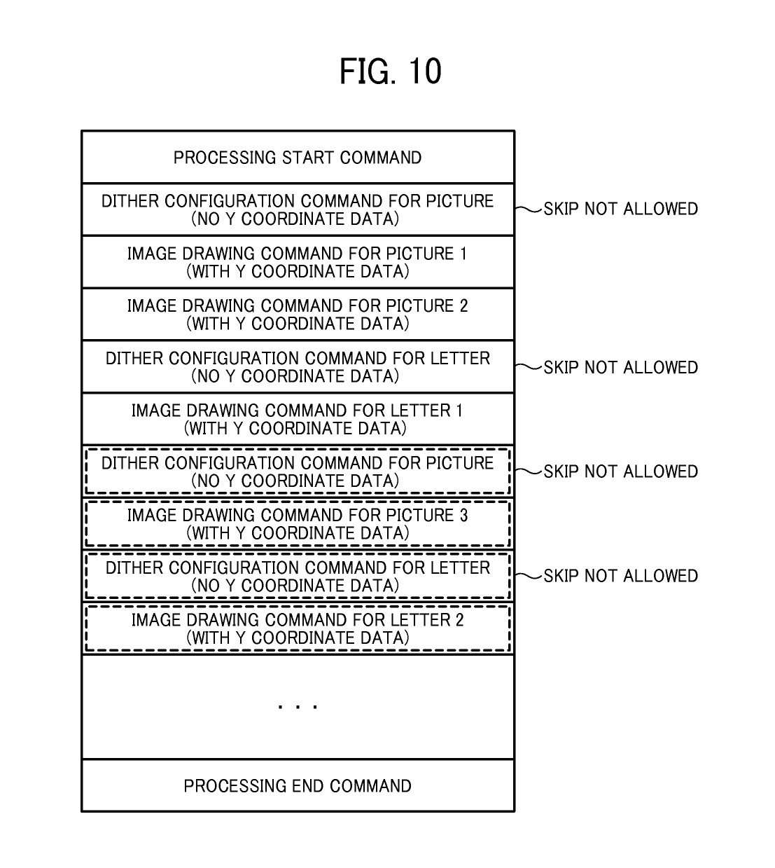

Such reading of command data as illustrated in FIG. 9 is executed in common for the drawing processes of respective bands described in FIG. 8. Thus, the commands for objects that are not included in a target band are also read. FIG. 10 is a diagram in which the items of data required for processing the fifth band illustrated in FIG. 8 are surrounded by broken lines.

As illustrated in FIG. 8, the “letter 2” and “picture 3” are included in the fifth band. Thus, as illustrated in FIG. 10, the required data includes the configuration command and the drawing command for “letter 2” and “picture 3”. In contrast, as described above, the command data itself is read in the order illustrated in FIG. 10.

In this case, since the drawing command includes the information “Y coordinate” and “image height” as described in FIG. 5, it is possible to determine whether the object is included in the target band based on the command data. As a result, since the “image drawing command for picture 1,” the “image drawing command for picture 2,” and the “image drawing command for letter 1” illustrated in FIG. 10 are not included in the target band, it may be reasonable to omit the reading of actual data from the intermediate data memory 313.

In contrast, since the configuration command does not include information that indicates the position on a page as illustrated in FIG. 6, it is not possible to determine whether the configuration command is the information required for the target band. As a result, the processing of the fifth band involves reading of actual data based on the “dither configuration command for picture” appearing ahead of the “image drawing command for picture 1” or the “dither configuration command for letter” appearing ahead of the “image drawing command for letter 1”. Thus, the processing is delayed by an amount corresponding to the reading.

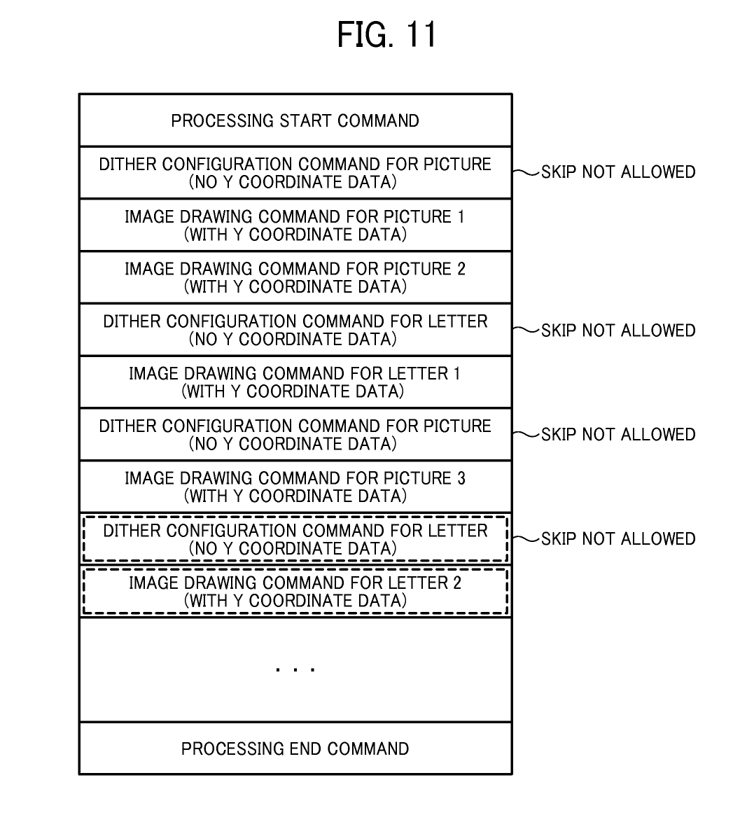

FIG. 11 is a diagram in which the items of data required for processing the seventh band illustrated in FIG. 8 are surrounded by broken lines. In the seventh band, as illustrated in FIG. 11, the configuration command and drawing command for “letter 2” are the required data. Thus, in the case of the seventh band, reading of the actual data based on the dither configuration commands, respectively, appearing ahead of the “image drawing commands for pictures 1 and 2,” the “image drawing command for letter 1,” and the “image drawing command for picture 3” is an unnecessary process.

In order to obviate such an unnecessary process, the PDL application 300 according to the present embodiment generates information allowing the intermediate data generator 301 to determine whether the configuration command such as the dither configuration command illustrated in FIG. 6 is required for the respective bands when generating the intermediate data. In this way, it is possible to omit reading of the actual data corresponding to a command such as the image drawing command that is not required for a target band.

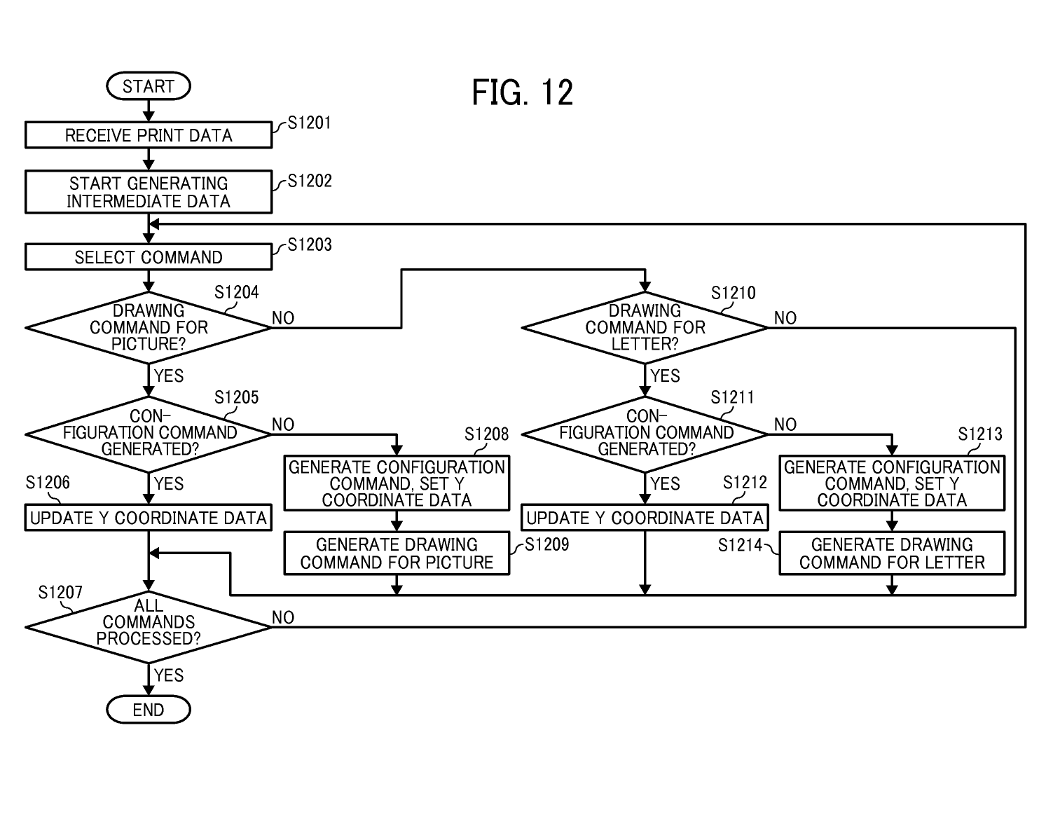

FIG. 12 is a flowchart of the operation of the intermediate data generator 301 according to the present embodiment. As illustrated in FIG. 12, upon receiving print data from the main controller 101 (S1201), the intermediate data generator 301 starts generating intermediate data (S1202) and selects commands included in the print data sequentially (S1203).

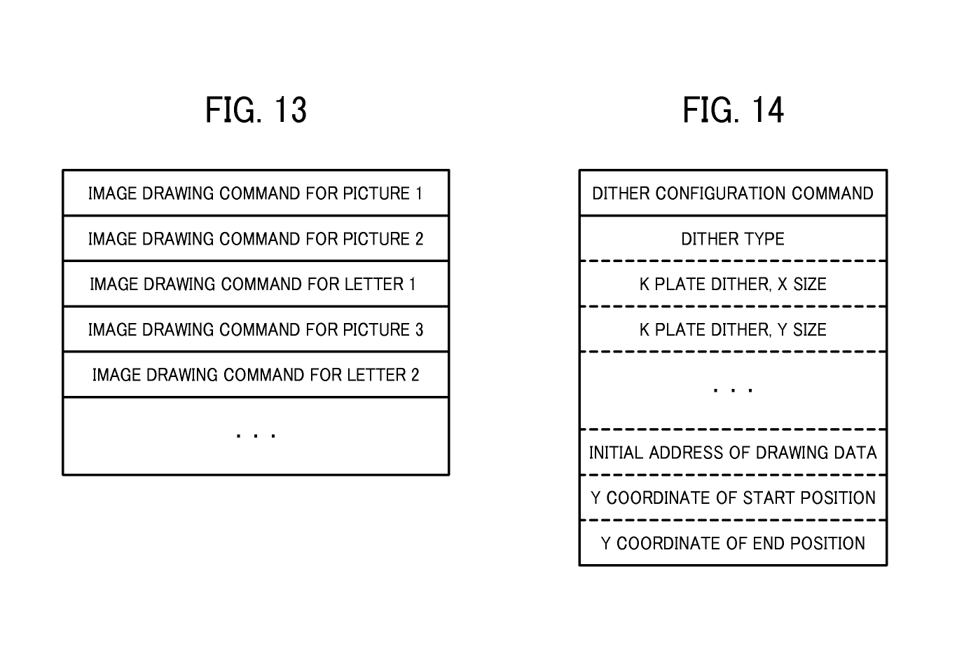

FIG. 13 is a diagram of an example of information included in the print data. The print data illustrated in FIG. 13 includes a drawing command for objects included in an image. In S1203, the intermediate data generator 301 selects the respective commands illustrated in FIG. 13 sequentially.

The intermediate data generator 301 having selected a command checks whether the selected command is a drawing command for pictures or a drawing command for letters (S1204). When the selected command is a drawing command for pictures (S1204: YES), and a dither configuration command for pictures has not yet been generated (S1205: NO), the intermediate data generator 301 generates the dither configuration command for pictures as described in FIG. 6 and configures Y coordinate data based on the drawing position included in the selected drawing command as illustrated in FIG. 14 (S1208). After that, the intermediate data generator 301 generates a drawing command for pictures based on the selected command (S1209).

On the other hand, when such a configuration command as illustrated in FIG. 14 has already been generated, the intermediate data generator 301 updates the Y coordinate data based on the drawing position included in the selected drawing command (S1206). The process of S1206 will be described by referring to FIG. 8. For example, when the drawing command for “picture 1” is selected and dither configuration data is generated by the process of S1208, the Y coordinate data at that time has a value corresponding to “picture 1”.

In contrast, when the drawing command for “picture 2” is selected subsequently, the Y coordinate data is updated by the process of S1206 to have values that indicate the range in the Y-direction that includes “picture 1” and “picture 2”. Further, when the drawing command for “picture 3” is selected subsequently, the Y coordinate data is updated by the process of S1206 to have values that indicate the range in the Y-direction that includes “picture 1,” “picture 2,” and “picture 3”.

When it is determined in S1204 that the selected command is not a drawing command for pictures (S1204: NO), the intermediate data generator 301 determines whether the selected command is a drawing command for letters (S1210). When the selected command is a drawing command for letters (S1210: YES), and a dither configuration command for letters has not yet been generated (S1211: NO), the intermediate data generator 301 generates the dither configuration command for letters as described in FIG. 6 and configures the Y coordinate data based on the drawing position included in the selected drawing command as illustrated in FIG. 14 (S1213). After that, the intermediate data generator 301 generates a drawing command for letters based on the selected command (S1214).

On the other hand, when such a configuration command as illustrated in FIG. 14 has already been generated, the intermediate data generator 301 updates the Y coordinate data based on the drawing position included in the selected drawing command (S1212). The process of S1212 executes the process described for the drawing command for pictures on the drawing command for letters.

On the other hand, when the selected command is not a drawing command for letters (S1210: NO), the intermediate data generator 301 executes a process corresponding to the command. The intermediate data generator 301 repeats the processes starting with S1203 for all commands included in the print data (S1207: NO). When all commands have been processed (S1207: YES), the process ends.

By such a process, the configuration data included in the intermediate data generated by the intermediate data generator 301 according to the present embodiment includes information on the range in the Y-axis direction to which the dither data is to be applied as the “Y coordinate of drawing start position” and “Y coordinate of drawing end position” for each picture and letter as illustrated in FIG. 14. In this way, similarly to the case of the drawing command, it is possible to determine whether the configuration data is the data required for the target band.

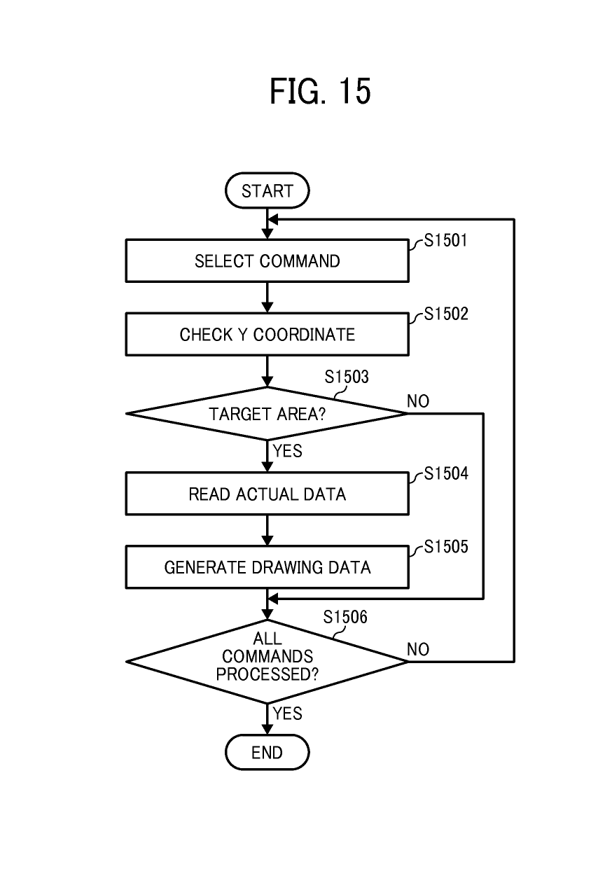

Next, a drawing process based on the intermediate data according to the present embodiment will be described with reference to FIG. 15. As illustrated in FIG. 15, the hardware accelerator 400 starts the drawing process according to the control of the hardware controller 314. Upon starting the process, the hardware accelerator 400 selects the commands stored in the HA sub memory 401 in such an order as illustrated in FIG. 9 (S1501) and checks the Y coordinate by referring to the “Y coordinate of drawing start position” and the “image height” illustrated in FIG. 5 or the “Y coordinate of drawing start position” and the “Y coordinate of drawing end position” illustrated in FIG. 14 (S1502).

When the checked Y coordinate area overlaps the target band area described in FIG. 8 (S1503: YES), the hardware accelerator 400 reads the actual data from the intermediate data memory 313 based on the address of actual data included in the command (S1504) and executes a drawing data generation process (S1505).

On the other hand, when the checked Y coordinate area does not overlap the target band area described in FIG. 8 (S1503: NO), the hardware accelerator 400 omits the processes of S1504 and S1505. In other words, a pixel information generator implemented by the hardware accelerator 400 reads actual data to generate pixel information only the range of the checked Y coordinates is included at least partially in the target band.

The hardware accelerator 400 repeats the processes starting with S1501 until all commands stored in the HA sub memory 401 are processed for one page of data (S1506: NO). When all commands have been processed (S1506: YES), the process ends. In determination of S1506, the “processing end command” illustrated in FIG. 10 can be referred to.

As described above, the band data generation operation according to the present embodiment can omit the reading of unnecessary actual data based on the Y coordinate data included in the command data. Due to this, it is possible to generate drawing data efficiently and to shorten the time required until printing is executed.

In the present embodiment, a case in which the “Y coordinate of drawing start position” and the “Y coordinate of drawing end position” as illustrated in FIG. 14 are set as the Y coordinate data of the configuration command is illustrated by way of an example. In this case, for example, when a picture is included in a band appearing further ahead of the seventh band illustrated in FIG. 8, the “Y coordinate of drawing start position” is at the position corresponding to the first band and the “Y coordinate of drawing end position” is at the position corresponding to the band appearing further ahead of the seventh band. As a result, a band which appears later than the seventh band and in which no picture is included is also determined to be within the range of a configuration command.

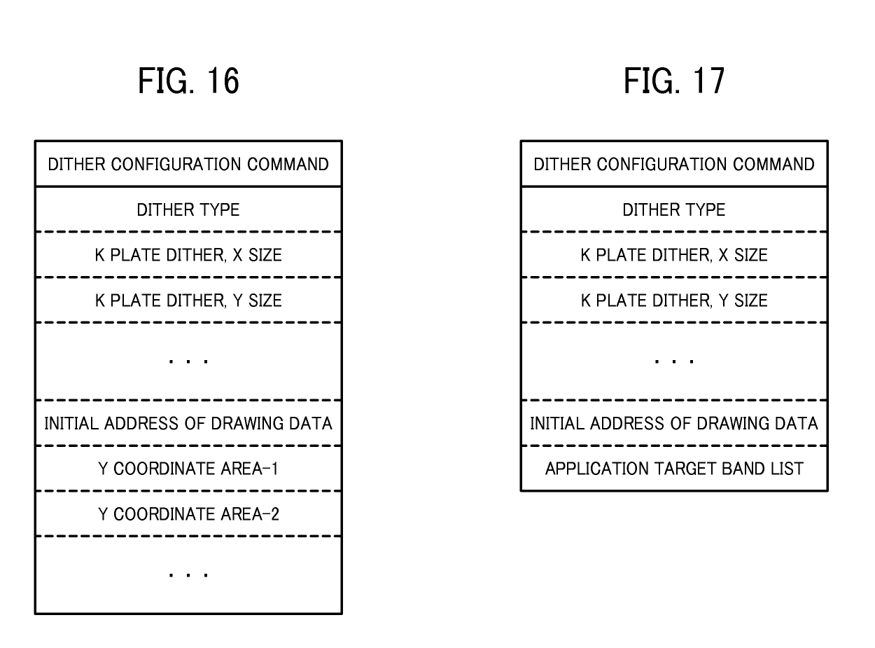

In contrast, this problem can be solved by designating a plurality of Y coordinate areas according to an area in which a picture or a letter is included like “Y coordinate area 1,” “Y coordinate area 2,” and the like as illustrated in FIG. 16.

Moreover, the information subject to the determination in S1502 and S1503 is not limited to the Y coordinate data described above. The purpose of the determination in S1502 and S1503 is to determine whether the command at issue is a command required for the target band. Thus, as illustrated in FIG. 17, an “application target band list” may be configured for respective configuration commands.

In the example of FIG. 17, during the operation of FIG. 12, the intermediate data generator 301 determines a corresponding band based on the values indicating the Y coordinate area of each band and the Y coordinate area of the selected drawing command and configures the “application target band list” illustrated in FIG. 17.

Moreover, in the embodiment, the operation of the hardware accelerator 400 reading the actual data is made efficient, and the operation of the software drawing processor 315 reading the actual data is not made efficient. This is because the memory access of the hardware accelerator 400 connected via the I/F 50 is relatively slower than the memory access of the software drawing processor 315 configured as the CPU 10.

That is, the present embodiment is effective when applied to the memory access of the hardware accelerator 400. However, this is an example, and although the access of the software drawing processor 315 to the intermediate data memory 313 is fast, by applying the present embodiment, it is possible to omit the reading of unnecessary actual data and to further increase the processing speed.

That is, when the software drawing processor 315 operates as a pixel information generator and the software drawing processor 315 executes the operation described in FIG. 15, it is possible to omit the process of reading unnecessary actual data.

Numerous additional modifications and variations are possible in light of the above teachings. It is therefore to be understood that within the scope of the appended claims, the disclosure of the present invention may be practiced otherwise than as specifically described herein. For example, elements and/or features of different illustrative embodiments may be combined with each other and/or substituted for each other within the scope of this disclosure and appended claims.

Each of the functions of the described embodiments may be implemented by one or more processing circuits or circuitry. Processing circuitry includes a programmed processor, as a processor includes circuitry. A processing circuit also includes devices such as an application specific integrated circuit (ASIC) and conventional circuit components arranged to perform the recited functions.

The present invention can be implemented in any convenient form, for example using dedicated hardware, or a mixture of dedicated hardware and software. The present invention may be implemented as computer software implemented by one or more networked processing apparatuses. The network can comprise any conventional terrestrial or wireless communications network, such as the Internet. The processing apparatuses can compromise any suitably programmed apparatuses such as a general purpose computer, personal digital assistant, mobile telephone (such as a WAP or 3G-compliant phone) and so on. Since the present invention can be implemented as software, each and every aspect of the present invention thus encompasses computer software implementable on a programmable device. The computer software can be provided to the programmable device using any storage medium for storing processor readable code such as a floppy disk, hard disk, CD ROM, magnetic tape device or solid state memory device.

The hardware platform includes any desired kind of hardware resources including, for example, a central processing unit (CPU), a random access memory (RAM), and a hard disk drive (HDD). The CPU may be implemented by any desired kind of any desired number of processor. The RAM may be implemented by any desired kind of volatile or non-volatile memory. The HDD may be implemented by any desired kind of non-volatile memory capable of storing a large amount of data. The hardware resources may additionally include an input device, an output device, or a network device, depending on the type of the apparatus. Alternatively, the HDD may be provided outside of the apparatus as long as the HDD is accessible. In this example, the CPU, such as a cache memory of the CPU, and the RAM may function as a physical memory or a primary memory of the apparatus, while the HDD may function as a secondary memory of the apparatus.

1. An image forming apparatus comprising:
a figure information generator to generate figure information in which items of information are grouped for each figure to be drawn in a printing target image based on a print execution command, the figure information including:
drawing information of the figure including command data for executing drawing and actual data indicating the content of the drawing; and
configuration information of the figure including command data for executing configuration and actual data indicating the content of the configuration, the command data of the configuration information including area information indicating a configuration target area of the printing target image to which the configuration is applied; and
a pixel information generator to read the actual data only when a range indicated by the area information of the command data is included at least partially in a target divided area of the printing target image, and generate pixel information of each pixel forming the printing target image based on the figure information using the read actual data, for each one of a plurality of divided areas of the printing target image.

2. The image forming apparatus according to claim 1, wherein
the figure information generator generates the command data including area information indicating the configuration target area of the printing target image based on a position of a target figure to be applied with the configuration is displayed on the target printing image.

3. The image forming apparatus according to claim 2, wherein, when the command data of the drawing information indicates a plurality of figures are to be drawn, the area information includes a plurality of items of area information generated for each one of the plurality of figures to be drawn.

4. The image forming apparatus according to claim 1, wherein
the figure information generator further generates information that designates the target divided are of the plurality of divided areas as the area information.

5. The image forming apparatus according to claim 1, wherein
the configuration information is information on configuration of dithering.

6. The image forming apparatus according to claim 1, wherein
the configuration information is information on configuration of a y-correction value.

7. The image forming apparatus according to claim 1, wherein
the pixel information generator is an integrated circuit configured to generate the pixel information based on the figure information,
the command data is stored in a dedicated memory provided in order to read information from the integrated circuit, and
the actual data is stored in a shared memory.

8. A method of generating pixel information to be used for printing an image, comprising:
generating figure information in which items of information are grouped for each figure to be drawn in a printing target image based on a print execution command,
the figure information including:
drawing information of the figure including command data for executing drawing and actual data indicating the content of the drawing; and
configuration information of the figure including command data for executing configuration and actual data indicating the content of the configuration, the command data of the configuration information including area information indicating a configuration target area of the printing target image to which the configuration is applied;
reading the actual data only when a range indicated by the area information of the command data is included at least partially in a target divided area of the printing target image; and
generating pixel information of each pixel forming the printing target image based on the figure information using the read actual data, for each one of a plurality of divided areas of the printing target image.

9. The method of claim 8, wherein the generating includes:
generating the command data including area information indicating the configuration target area of the printing target image based on a position of a target figure to be applied with the configuration is displayed on the target printing image.

10. The method of claim 9, wherein, when the command data of the drawing information indicates a plurality of figures are to be drawn, the area information includes a plurality of items of area information generated for each one of the plurality of figures to be drawn.

11. The method of claim 8, wherein the generating further includes:
generating information that designates the target divided are of the plurality of divided areas as the area information.

12. A non-transitory recording medium storing a plurality of instructions, which, when executed by one or more processors, cause the processors to perform a method of generating pixel information to be used for printing an image, comprising:
generating figure information in which items of information are grouped for each figure to be drawn in a printing target image based on a print execution command,
the figure information including:
drawing information of the figure including command data for executing drawing and actual data indicating the content of the drawing; and
configuration information of the figure including command data for executing configuration and actual data indicating the content of the configuration, the command data of the configuration information including area information indicating a configuration target area of the printing target image to which the configuration is applied;
reading the actual data only when a range indicated by the area information of the command data is included at least partially in a target divided area of the printing target image; and
generating pixel information of each pixel forming the printing target image based on the figure information using the read actual data, for each one of a plurality of divided areas of the printing target image.
